(19) United States
(12) Patent Application Publication
(10) Pub. No.: US 2008/0242264 A1
(43) Pub. Date: Oct. 2, 2008

(54) METHODS AND SYSTEM FOR TERMINAL AUTHENTICATION USING A TERMINAL HARDWARE INDENTIFIER

(75) Inventors: AMIT MALIK, PALATINE, IL (US); SHREESHA RAMANNA, VERNON HILLS, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/693,932

(22) Filed: Mar. 30, 2007

(51) Int. Cl. H04M 1/66

(52) U.S. Cl. 455/411

(57) ABSTRACT

A system includes an access network and an authentication server. The access network: requests and receives a hardware ID for a terminal attempting access to a network that provides access to a service; constructs a user ID that includes the hardware ID; forwards the user ID for use in a first authentication process for the terminal; and receives a response that indicates an authorization status for the terminal. The authentication server: receives the user ID; determines, from the user ID, the authorization status for the terminal, which identifies at least one of whether the terminal is authorized to use the service and whether the terminal is local or roaming; and provides the response to the access network, which indicates the authorization status.

### TECHNICAL FIELD

The technical field relates generally to wireless communication systems and more particularly to terminal authentication in wireless systems using a terminal hardware identifier.

### BACKGROUND

In wireless communication systems some form of terminal authentication is performed to determine whether a terminal is authorized to access the system and to use certain services in the system. Take for instance a system that includes a radio access network (RAN) that uses protocols defined in 3^{rd} Generation Project Partnership 2 “3GPP2” A.S009-A, titled Interoperability Specification (IOS) for High Rate Packet Data RAN Interfaces with Session Control in the Packet Control Function, which provides a technique for authenticating an access terminal (AT) before the AT is allowed to use a HRPD service. In this system an access terminal could be a local terminal that may or may not be authorized to use the HRPD service or a roaming terminal that may or may not be authorized to use the HRPD service. However, regardless of the AT that is attempting to access the system and the circumstances under which the access attempt occurs, the same lengthy authentication procedure (e.g., Challenge Handshake Authentication Protocol (CHAP) or another suitable protocol) is performed to determine whether an AT is authorized to use the HRPD service. Moreover, irrespective of whether the AT is authorized to use the HRPD service, its session information remains stored within the RAN, thereby, using valuable memory resources in the system and requiring larger memory reserves as the system expands.

Thus, there exists a need for methods and a system for terminal authentication in a wireless communication system, which addresses at least some of the shortcomings of past and present terminal authentication techniques and/or mechanisms.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is block diagram of a system in accordance with some embodiments.

FIG. 2 is a flow diagram of a method implemented in an access network in accordance with some embodiments.

FIG. 3 is a flow diagram of a method implemented in an authentication server in accordance with some embodiments.

FIG. 4 is a signaling diagram in accordance with some embodiments.

FIG. 5 is a signaling diagram in accordance with some embodiments.

FIG. 6 is a signaling diagram in accordance with some embodiments

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, terminal authentication is performed in a wireless communications network, wherein an access network constructs a user identification (ID) using a hardware ID for the terminal and sends that user ID to an authentication server to use in a first authentication process for the terminal. The authentication server determines, from the user ID (constructed from the hardware ID), an authorization status for the terminal and sends to the access network a response that indicates the authorization status. The authorization status for the terminal can identify at least one of: whether the terminal is authorized to use the service; and whether the terminal is local or roaming. When the terminal is a local terminal, a second authentication process that is normally used in the network can be bypassed. Moreover where the terminal is an unauthorized (unsubscribed to the service) local terminal, session data stored in network memory for use of the service is erased from memory.

Advantages of embodiments include: efficient use of network resources and relief of capacity impacts from unsubscribed users; local and roaming terminals are distinguished through hardware ID; improved network capacity by reclaiming sessions from unauthorized terminals; faster call setup time for authorized terminals when the second terminal authentication is bypassed; and seamless handoff across access technologies that use dissimilar technologies by using a common identifier (i.e., a hardware ID). Those skilled in the art will realize that the above recognized advantages and other advantages described herein are merely illustrative and are not meant to be a complete rendering of all of the advantages of the various embodiments.

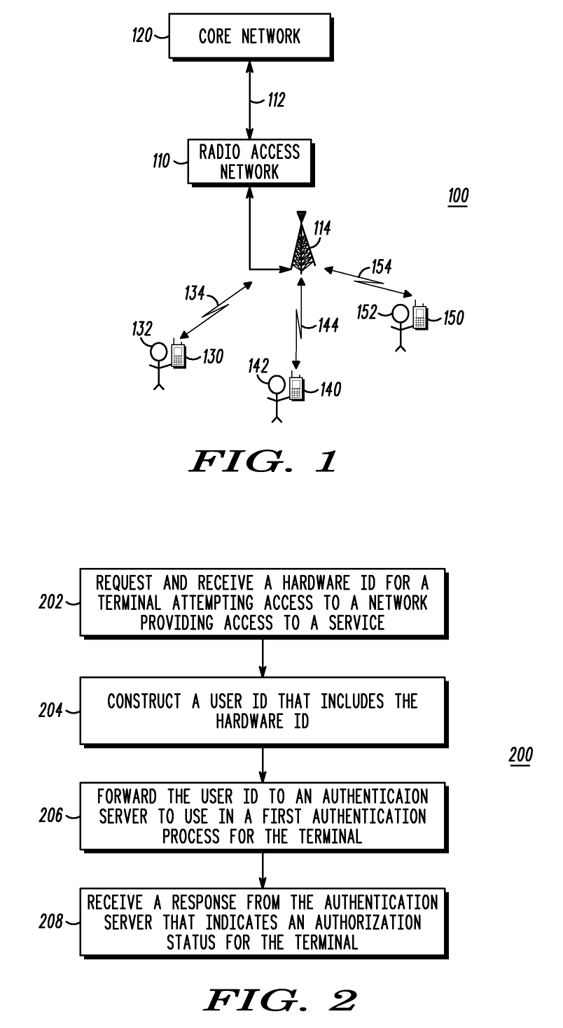

Referring now to the drawings, and in particular FIG. 1, a block diagram of a wireless communication system in accordance with some embodiments is shown and indicated generally at 100. System 100 comprises a radio access network (RAN) 110 that is operatively coupled and provides connectivity 112 to a core network 120, which provides a service to which users can subscribe. RAN 110 can be wirelessly accessed (e.g., 134, 144, 154) by a terminal (e.g., respectively terminals 130, 140, 150) via an access network 114. System 100 can use any of a number of protocols and access technologies, such as for instance the UTRA (Universal Terrestrial Radio Access) access technology used to access a UMTS (Universal Mobile Telecommunications System), CDMA2000®, GERAN (GSM Edge Radio Access Network) supporting the EDGE (Enhanced Data Rates for Global Evolution) technology, to name a few.

In general a RAN is defined as including all of the entities needed in a given implementation for providing connectivity between a terminal and the core network, including an authentication server (not shown). The authentication server (also known in the art as an Authentication, Authorization and Accounting or AAA server) performs (among other processes and procedures) a terminal authentication procedure, wherein the terminal is authenticated by the AAA server in order to verify that the terminal is “authorized” to (1) access the core network and to (2) use a given service provided within the network by a local service provider that maintains the AAA server. A service provider can be identified based on a domain or realm name.

A terminal that is authorized to use the core network may be “local” or “roaming”. Local means that a user operating the terminal has a formal customer-vender relationship with the local service provider that maintains the AAA server. Roaming means that a user operating the terminal has a formal customer vendor relationship with a service provider that is not the local access/service provider that maintains the radio access network. Examples of protocols used by a AAA server include, Remote Authentication Dial in User Service (RADIUS) protocol as defined in Internet Engineering Task Force (IETF) Request for Comment (RFC) 2865 dated June 2000 (and all successor documents), DIAMETER as defined in IETF RFC 3588 dated September 2003 (and all successor documents), and the like.

An AN is a logical entity in the RAN used at least for radio communications with a terminal. For purposes of the teachings herein, the AN is further the logical entity that provides functionality in accordance with various embodiments. ANs are commonly known by other names such as base stations, base sites, and the like, depending on the system implementation. The core network is the service providing network, wherein any type of service is contemplated within the scope of the teachings herein. The core network may be, for example, a packet switched data network that provides a packet data service such as internet access, corporate VPN (virtual private network), Multimedia service and content downloads. A terminal is intended to broadly cover many different types of devices that can wirelessly receive and transmit signals and that can operate in a wireless communication system. Such devices are also commonly known as mobile devices, subscriber units, mobile stations, access terminals and the like, and the use of the term terminal herein is meant to include all such devices.

In the implementation shown in FIG. 1 only one core network, one RAN, one AN, and three terminals are shown for clarity and simplicity of illustration. However a system comprising any number of these elements is contemplated within the scope of the teachings herein.

In order to facilitate a better understanding of the embodiments, the teachings will be described by reference to a system that uses protocols defined in 3^{rd} Generation Project Partnership 2 “3GPP2” Document A.S009-A v10, dated March 2006 (and all successor documents), titled Interoperability Specification (IOS) for High Rate Packet Data (HRPD) Radio Access Network Interfaces with Session Control in the Packet Control Function, which may be accessed via web page http://www.3gpp2.org/Public_html/specs/A.S0009-A_v1.0_{—}060228.pdf. Those skilled in the art, however, will recognize and appreciate that the specifics of this example are merely illustrative of some embodiments and that the teachings set forth herein are applicable in a variety of alternative settings. For example, since the teachings described do not depend on any particular standard (or proprietary) protocols used or the type of access technology used or the service provided, they can be applied to any type of wireless communication system although one implementing document A.S009-A standard protocols is shown in this embodiment. As such, other alternative implementations of using different types of standard (or proprietary) protocols and access technologies and providing for different types of services are contemplated and are within the scope of the various teachings described.

In accordance with this illustrative embodiment (utilizing A.S009-A standard protocols), core network 120 is a packet switched data network providing a High Rate Packet Data (HRPD) Service to which users (e.g., 132, 142 or 152) can subscribe and access using a terminal (e.g., respectively, terminals 130, 140 and 150). Core network 120 may be, for example, the Internet or may be a private packet switched network. RAN 110 comprises one or more access networks (AN), authentication servers (not shown) also commonly referred to as AN-AAAs, and packet control functions (PCF). A PCF is an entity that manages the relay of packets between the AN and a PDSN (Packet Data Servicing Node). In addition, in accordance with embodiments, the AN communicates with an AN-AAA server via the PCF. A PDSN routes terminal originated or terminal terminated packet data traffic and establishes, maintains and terminates link layer sessions to terminals.

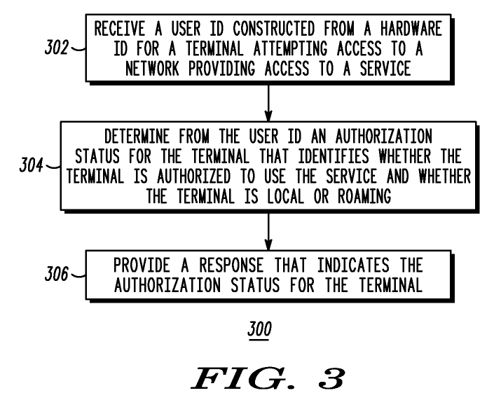

Turning now to FIG. 2 a flow diagram of a method implemented in an access network in accordance with some embodiments is shown and generally indicated at 200. It should be realized that method 200 includes functionality that may be performed in a single hardware device in the RAN or a combination of hardware devices in the RAN. In stating that method 200 is performed in an “AN”, AN in this context includes any physical devices used to perform the functionality. FIG. 3 illustrates a flow diagram of a method 300 implemented in an authentication server in accordance with some embodiments. Methods 200 and 300 will be discussed contemporaneously. The functionality provided for in method 200 and 300 can be performed using any suitable processing device, such as one described below.

Referring first to method 200, at 202, the AN requests and receives a hardware identification (ID) for a terminal (e.g., terminal 130) attempting access to network 120 via RAN 110. A hardware ID comprises one or more letters and/or numbers used to uniquely identify a piece of hardware, which in this case is terminal 130. Examples of a hardware ID include, but are not limited to a mobile equipment identifier, an electronic serial number, etc. To enable terminal authentication to be performed by an authentication server, the AN constructs (at 204) a user ID that includes the hardware ID and forwards (206) the user ID to the authentication server.

A user ID generally identifies a person (e.g., user 132) operating terminal 130 and is used for user authentication by the core network or the service provider. An example of a user ID is a Network Access Identifier (NAI), for instance as defined in IETF RFC 2486 dated January 1999 (and all successive documents), which generally has a format of username realm, with the realm serving as a local domain name to identify the local domain to which the user belongs. Examples of NAIs include fred@3com.com, fred_smith@big-co.com, eng!nancy@bigu.edu, to list a few. In an embodiment, the user ID constructed by the AN and sent to the authentication server has the format of hardwareID@realm, wherein the name identifying a person is simply replaced with the hardware ID, and wherein the user ID (e.g., NAI) is used for terminal authentication by the RAN in accordance with embodiments. However, in other embodiments it can be envisioned that a suitable algorithm can be applied to the hardwareID to modify the hardware ID before replacing the username with the modified hardware ID to generate the user ID that is sent to the authentication server.

Upon receiving (302) the user ID, the authentication server determines from the user ID an authorization status for the terminal. In an embodiment, the authorization status identifies whether the terminal is local or roaming and whether the terminal is authorized to use a particular service. Whether the terminal is local or roaming can be identified by the realm (or local domain name) that comprises the user ID. Whether the terminal is authorized to use the service can be determined by the hardware ID (or modified version thereof). For example, the authentication server may have stored in a suitable storage mechanism (e.g., database, memory element, etc.) the hardware IDs for the terminals that belong to the local domain and that are authorized to use a particular service. The authentication server compares the received hardware ID to the stored hardware IDs, and if a match is indicated then the authorization status for that terminal is that the terminal is local and is authorized to use the service. If there is no match, then the terminal is local but is not authorized to use the service.

The authentication server provides (306) a response to the AN that indicates the authorization status of the terminal including whether the terminal is local or roaming and whether the terminal is authorized to use the service. Upon receipt (208) of the response, the AN can determine how to proceed with the terminal, e.g., whether to establish a connection for the terminal to use the service, whether additional authentication procedures are needed, etc.

The response can include one or more predefined indicators. An example of one such indicator is a “true” (i.e., valid) International Mobile Subscriber Identity (IMSI), which is a unique 15 digit number assigned to a terminal at the time of service subscription and typically contains a mobile country code, a mobile network code, terminal identification number, and a national mobile subscriber identity. Thus, where the AN receives a response having a valid IMSI, the AN determines that the terminal is local and is authorized to use the service, and the AN accordingly initiates any procedures required to establish a connection to enable the terminal to use the service, which can be done without any further authentication process being performed.

Further to the IMSI indicator example, the indicator may be an invalid IMSI, wherein the IMSI value is included in the response packet structure in the same location as a valid IMSI but the value indicates that it is not a valid IMSI. For example, the IMSI may have a value equivalent to zero or some other predetermined invalid IMSI value. Thus, where the AN receives a response having an invalid IMSI, the AN determines that the terminal is local and is not authorized to use the service, and the AN acts accordingly. In one embodiment, where information to enable use of the service has been stored in a memory/storage device in the RAN (also referred to herein as a network memory element), the AN causes such information to be cleared or erased from the network memory element. The stored information may include, for example, radio specific protocol information about the terminal's capability such as protocol information, services that the terminal is capable of performing, identifiers assigned to the terminal, and the like.

In addition, the AN may perform other functions upon determining that the response indicates that the terminal has an authorization status of local but unauthorized to use the service. For example, the AN may cause resources to be released that were reserved to enable the terminal to use the service. In one embodiment, those resources include a Unicast Access Terminal Identifier (UATI) assigned from a pool of reserved UATIs. Moreover, the AN can optionally assign a different UATI to the terminal from a second pool of UATIs, wherein each UATI in this second pool indicates to the AN that the terminal is unauthorized to use the service. Therefore, if the terminal (which is mobile) moves around and later attempts to re-authenticate with the AN, the AN can determine from the UATI alone the authorization status of the terminal without having to send a user ID to the authentication server to perform an authentication process for the terminal.

Other indicators may be used in the response from the authentication server to the AN to indicate an authorization status for the terminal. For example, the response may have one or more fields that can be used to indicate the authorization status for the terminal. In addition, where the authorization status for the terminal is roaming, the AN can act accordingly by, for example, initiating a more detailed terminal authentication process to determine whether to complete a connection for the terminal to use the service, wherein additional information about the terminal and/or user operating the terminal is requested. This more detailed authentication process may comprise a Challenge Handshake Authentication Protocol (CHAP) as defined in RFC 1994 dated August 1996 (and all successive documents) or Extensible Authentication Protocol (EAP) as defined in RFC 3748 dated June 2004 (and all successive documents).

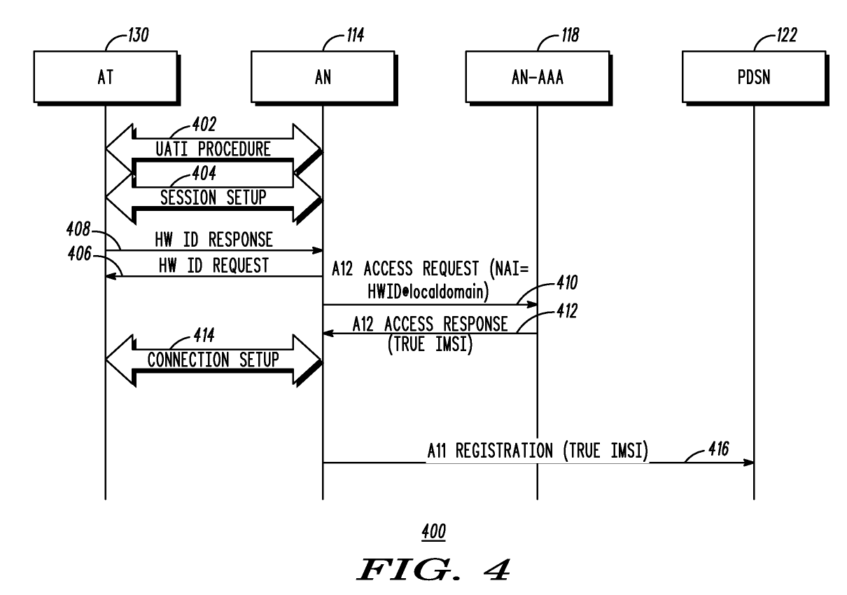

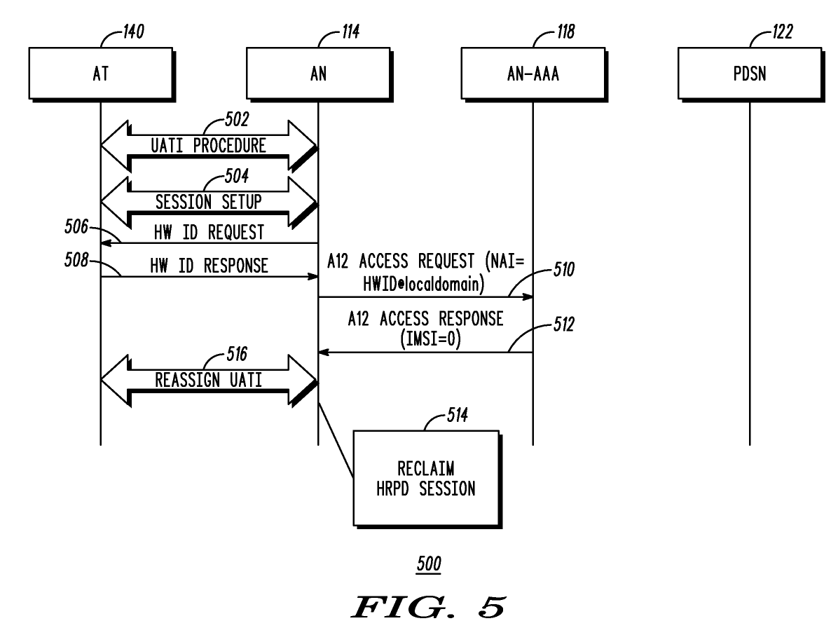

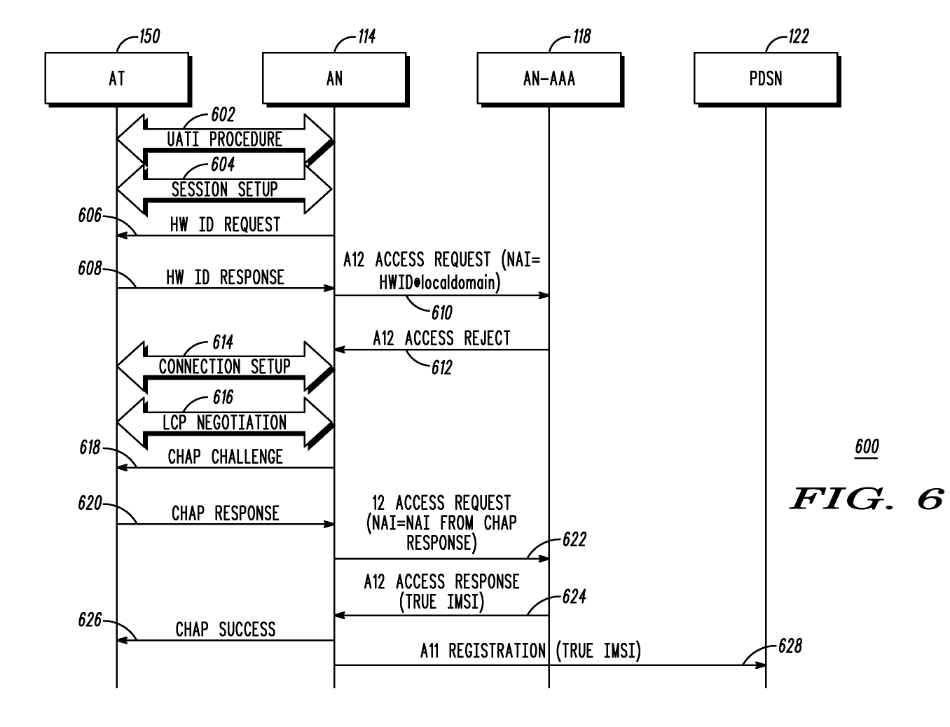

FIGS. 4 to 6 are signaling diagrams, in accordance with embodiments of the teachings herein, corresponding to three terminal authorization scenarios in a system that uses A.S009-A standard protocols. FIG. 4 is the signaling diagram 400 directed to AT 130, which is local and authorized to use the HRPD service. FIG. 5 is the signaling diagram 500 directed to AT 140, which is local and not authorized to use the HRPD service. FIG. 6 is the signaling diagram 600 directed to AT 150, which is roaming. Each of the three signaling diagrams illustrate signaling to and/or from the ATs, AN 114, an AN-AAA server 118 comprising the RAN 110, and a PDSN 122 comprising the core network 120.

Turning first to FIG. 4, upon AT 130 establishing link 134 with AN 114 a UATI procedure is performed (402) to assign a unique identifier to the AT 130 to identify this mobile within a service area of the RAN 110. The unique identifier is a UATI from a reserved pool of UATIs. Thus, if AT 130 moves in between ANs in the RAN, it can be readily identified by the assigned UATI, and many procedures (including 402) can be bypassed, which are normally performed upon the AT establishing a wireless link with the AN. A session setup (404) is also performed between the AT 130 and the AN 114, which is a negotiation procedure to exchange capabilities and protocol values that result in the AN 114 storing session specific information about the AT 130 within itself (or causing the session information to be stored somewhere else in the RAN). Since the UATI and session setup procedures are well known in the art, no further discussion of these procedures is included here for the sake of brevity.

The AN 114 sends a message (406) to AT 130 requesting its hardware ID (“HWID”). The message may comprise a proprietary message or may comprise an extension (e.g., a filed added) to a standard protocol message exchanged between the AT 130 and the AN 114, such as one exchanged during session setup. The AT 130 sends a message (408) to the AN 114 that includes the hardware ID. Message 408, likewise, may comprise a proprietary message or an extension to a standard protocol message exchanged between the AT 130 and the AN 114. AN 114 constructs a NAI using the hardware ID (e.g., having a format of NAI=HWID@localdomain) and sends a message (410) to the AN-AAA server 118, which comprises the NAI. In this implementation, the NAI is included in an A12 ACCESS REQUEST message.

The AN-AAA server 118 extracts the local domain name from the NAI and determines that AT 130 is local. The AN-AAA server 118 further extracts the HWID from the NAI and compares it with locally stored HWIDs and in this case finds a match, which indicates an authorization status for the AT 130 of local and authorized to use the HRPD service. Accordingly, the AN-AAA server 118 sends a message (412) to the AN 114, which indicates this authorization status. In this embodiment, the message comprises an A12 ACCESS RESPONSE message that includes a true or valid IMSI, although any other suitable message can be used or a field added, for instance, to an A12 ACCESS RESPONSE that includes a value that indicates the authorization status for the AT 130. Since the A12 ACCESS REQUEST and A12 ACCESS RESPONSE messages are well known in the art, no further discussion of these messages is included here for the save of brevity.

Upon receiving the message 412, AN 114 can determine from the message that the AT 130 is local and authorized to use the HRPD service due to the inclusion in the message of a valid IMSI. Accordingly, a second more detailed terminal authentication process (e.g., including a Link Control Protocol (LCP) and CHAP or some other authentication protocols) can be optionally bypassed and a connection setup (414) performed to establish radio connection with the AT 130 to provide the HRPD service. Moreover, the AN 114 sends an A11 registration message (416) to the PDSN 122, which includes the IMSI assigned to the AT 130, in order to initiate an A11 registration procedure. A11 registration establishes a conduit between the AN 114 and the core network 120 for AT 130 to send and/or receive information and/or data. Since the connection setup and A11 registration procedures are well known in the art, no further discussion of these procedures is included here for the sake of brevity.

Turning to FIG. 5, upon AT 140 establishing link 144 with AN 114 a UATI procedure is performed (502) to assign a UATI to AT 140. A session setup (504) is also performed between the AT 140 and the AN 114, which results in the AN 114 storing session specific information about the AT 140 within the RAN (e.g., in AN 114). The AN 114 sends a message (506) to AT 140 requesting its HWID, and the AT 140 responds with a message (508) to the AN 114 that includes the HWID. AN 114 constructs a NAI using the hardware ID and sends an A12 ACCESS REQUEST message (510) to the AN-AAA server 118, which comprises the NAI.

The AN-AAA server 118 extracts the local domain name from the NAI and determines that AT 140 is local. The AN-AAA server 118 further extracts the HWID from the NAI and compares it with locally stored HWIDs and in this case does not find a match, which indicates an authorization status for the AT 140 of local but unauthorized to use the HRPD service. Accordingly, the AN-AAA server 118 sends an A12 ACCESS RESPONSE message (512) to the AN 114, which indicates this authorization status. In this embodiment, the message 512 comprises an invalid IMSI having a predefined value (which in this case is IMSI=0) that indicates that the AT 140 is local but unauthorized to use the service.

Upon receiving the message 512, AN 114 can determine from the message that the AT 140 is local and unauthorized to use the HRPD service due to the inclusion in the message of an invalid IMSI. Accordingly, the AN 114 reclaims (514) the HRPD session, wherein the AN 114 erases the session specific information stored in the memory of the AN at session setup (504). In one embodiment, the AN 114 erases this information without informing the AT 140. The AN 114 further assigns the AT 140 a different UATI from a second pool of UATIs, wherein each UATI in the second pool indicates that a terminal is unauthorized to use the service. Thus, if AT 140 moves to a different AN in the RAN, the new AN can readily determine the authorization status of AT 140 without performing procedures 502 and 504 and without the exchange of signaling 506, 508, 510 and 512.

Turning to FIG. 6, upon AT 150 establishing link 154 with AN 114 a UATI procedure is performed (602) to assign a UATI to AT 150. A session setup (604) is also performed between the AT 150 and the AN 114, which results in the AN 114 storing session specific information about the AT 150 within the RAN (e.g., in AN 114). The AN 114 sends a message (606) to AT 150 requesting its HWID, and the AT 150 responds with a message (608) to the AN 114 that includes the HWID. AN 114 sends an A12 ACCESS REQUEST message (610) to the AN-AAA server 118, which comprises the NAI.

The AN-AAA server 118 extracts the local domain name from the NAI and determines that AT 150 is roaming. The AN-AAA server 118 does not need to extract the HWID for comparison for this roaming terminal. The AN-AAA server 118 sends an A12 ACCESS REJECT message (612) to the AN 114, which indicates an authorization status of AT 150 of roaming. Upon receiving the message 612, AN 114 can determine from the message that the AT 150 is roaming. Accordingly, the AN 114 performs connection setup (614) and further performs a second more detailed terminal authentication process to determine whether AT 150 is authorized to use the HRPD service. In this embodiment, the more detailed terminal authentication process includes LCP negotiation (616) to establish underlying layer 2 capabilities between 2 endpoints, and CHAP. Both LCP and CHAP are well known authentication protocols.

During CHAP, a CHAP CHALLENGE message (618) and a CHAP RESPONSE message (620) is exchanged between the AT 150 and the AN 114, resulting in the AN 114 receiving a NAI from the AT 150, which has the typical format of username realm. AN 114 sends an A12 ACCESS REQUEST message (622) to the AN-AAA server 118, which comprises this NAI. The AN-AAA 118 extracts the local domain name from the NAI and communicates with an authentication server in the local domain of roaming AT 150 to determine whether AT 150 is authorized to use the HRPD service. Any suitable signaling for obtaining this status is included within the scope of the teachings herein. In this case, the AN-AAA server 118 learns that AT 150 is in fact authorized to use the service and, therefore, sends an A12 ACCESS RESPONSE message (624) to AN 114, which indicates this authorization status using a valid IMSI. The AN 114, responsively, sends a CHAP SUCCESS message (626) to AT 150. Signaling 612, 618, 620, 622, 624 and 626 are well known in the art and will not be detailed here for the sake of brevity. Finally, the AN 114 sends an A11 registration message (628) to the PDSN 122, which includes the IMSI assigned to the AT 150, in order to initiate the A11 registration procedure.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for terminal authentication using a terminal HWID described herein. The non-processor circuits may include, but are not limited to, a radio receiver, a radio transmitter, signal drivers, clock circuits, power source circuits, and user input devices. As such, these functions may be interpreted as steps of a method to perform the terminal authentication using a terminal HWID described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
requesting and receiving a hardware identification (ID) for a terminal attempting access to a network providing access to a service;
constructing a user ID that includes the hardware ID;
forwarding the user ID to an authentication server to use in a first authentication process for the terminal; and
receiving a response from the authentication server that indicates an authorization status for the terminal.

2. The method of claim 1, wherein the user ID comprises a Network Access Identifier.

3. The method of claim 1, wherein the service is a High Rate Packet Data (HRPD) service.

4. The method of claim 1, wherein the authorization status identifies at least one of: whether the terminal is authorized to use the service; and whether the terminal is local or roaming.

5. The method of claim 4, wherein the response indicates an authorization status of the terminal being local and being unauthorized to use the service.

6. The method of claim 5 further comprising:
releasing resources reserved to use the service; and
erasing, from a network memory element, information stored to use the service.

7. The method of claim 6, wherein the resources comprise a Unicast Access Terminal Identifier (UATI) assigned from a first pool of reserved UATIs.

8. The method of claim 7 further comprising assigning a UATI to the terminal from a second pool of UATIs, wherein each UATI in the second pool indicates that the terminal is unauthorized to use the service.

9. The method of claim 5, wherein the response from the authentication server comprises an invalid International Mobile Subscriber Identity (IMSI).

10. The method of claim 4, wherein the response indicates an authorization status of the terminal being local and being authorized to use the service.

11. The method of claim 10, wherein the response from the authentication server comprises a valid International Mobile Subscriber Identity (IMSI).

12. The method of claim 10 further comprising completing a connection for the terminal to use the service without performing a second authentication process.

13. The method of claim 12, wherein the second authentication process comprises a Challenge Handshake Authentication Protocol.

14. The method of claim 4, wherein the response indicates an authorization status of the terminal being roaming.

15. The method of claim 14 further comprising performing a second authentication process to determine whether to complete a connection for the terminal to use the service.

16. The method of claim 15, wherein the response is an A12 Access Reject as defined in 3^{rd} Generation Project Partnership 2 “3GPP2” A.S009-A, titled Interoperability Specification (IOS) for High Rate Packet Data (HRPD) Radio Access Network Interfaces with Session Control in the Packet Control Function, and the second authentication process comprises a Challenge Handshake Authentication Protocol.

17. A method comprising:
receiving a user identification (ID) constructed from a hardware ID for a terminal attempting access to a network providing access to a service;
determining, from the user ID, an authorization status for the terminal that identifies at least one of whether the terminal is authorized to use the service and whether the terminal is local or roaming; and
providing a response that indicates the authorization status for the terminal.

18. A system comprising:
an access network,
requesting and receiving a hardware identification (ID) for a terminal attempting access to a network providing access to a service;
constructing a user ID that includes the hardware ID,
forwarding the user ID for use in a first authentication process for the terminal, and
receiving a response that indicates an authorization status for the terminal; and
an authentication server,
receiving the user ID,
determining, from the user ID, the authorization status for the terminal, which identifies at least one of whether the terminal is authorized to use the service and whether the terminal is local or roaming, and
providing the response to the access network, which indicates the authorization status.

19. The system of claim 18, wherein the system uses protocols defined in 3^{rd} Generation Project Partnership 2 “3GPP2” technical specification, titled Interoperability Specification (IOS) for High Rate Packet Data (HRPD) Radio Access Network Interfaces with Session Control in the Packet Control Function.

20. The system of claim 18, wherein the authentication server uses a Remote Authentication Dial in User Service (RADIUS) protocol as defined in Internet Engineering Task Force Request for Comment 2865.
